(19) United States
(12) Patent Application Publication
(10) Pub. No.: US 2007/0184421 A1
(43) Pub. Date: Aug. 9, 2007

(54) Behaviour modification through personal identification

(76) Inventor: Geoffrey Harold Tofler, Vaucluse (AU)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/644,403

(22) Filed: Dec. 21, 2006

(30) Foreign Application Priority Data
Dec. 23, 2005 (AU) 2005907313

(51) Int. Cl. G09B 19/00

(52) U.S. Cl. 434/236

(57) ABSTRACT

Methods and products for modifying behaviour in an individual are disclosed herein. Visual and/or audio representations of the individual are obtained (step 120) and superimposed over a character in an audio-visual presentation to portray behaviour of the individual to be modified and a predicted consequence of the to behaviour (step 130). The audio-visual presentation is then viewed by the individual to encourage a behaviour modification.

### FIELD OF THE INVENTION

The present invention relates to behaviour of individuals and more particularly to modification of an individual's behaviour through personal identification.

### BACKGROUND

It is desirable to stimulate or encourage positive behaviour and discourage negative behaviour in individuals. Negative behaviour may, for example, include substance abuse, smoking, excessive alcohol consumption and excessive food consumption, while positive behaviour may include not driving after alcohol consumption, sensible food intake and performing regular exercise.

Certain negative behaviour is notoriously difficult to modify or cure. For example, addicts are not readily able to give-up drugs, smoking or alcohol and overweight individuals do not readily eat less or exercise more to improve their health.

A need thus exists for effective methods and products that assist individuals to modify a particular behaviour. Current methods have limited success.

### SUMMARY

Aspects of the present invention provide methods and products for modifying behaviour in an individual.

An aspect of the present invention provides a method for modifying behaviour in an individual. The method comprises the steps of identifying behaviour in an individual to be modified, obtaining visual representations of the individual, superimposing that individual's visual representations over a character in an audio-visual presentation to portray the identified behaviour of the individual and a predicted consequence of the behaviour, and screening the audio-visual presentation to the individual.

Another aspect of the present invention provides a method of self-improvement for an individual. The method comprises the steps of viewing an audio-visual presentation that portrays behaviour of the individual and a predicted consequence of the behaviour and modifying that behaviour based on the predicted consequence.

A further aspect of the present invention provides a personalized audio-visual presentation for modifying behaviour in an individual. The audio-visual presentation comprises a recording of a character exhibiting the behaviour to be modified and a predicted consequence of that behaviour. Visual and/or audio representations of the individual are superimposed over the character in the audio-visual presentation.

The audio-visual presentation may further comprise visual and/or audio representations of at least one other individual known to the individual, which are superimposed over at least one character in the audio-visual presentation. Such other individuals may be relatives and/or friends of the individual. The identified behaviour may comprise a negative behaviour such as smoking, alcoholism, drug abuse, road rage, an eating disorder, child abuse and spouse abuse, or a positive behaviour such as not driving after alcohol consumption, regular exercise and sensible eating habits. The visual and audio representations may comprise video and audio recordings.

### BRIEF DESCRIPTION OF THE DRAWINGS

A small number of embodiments are described hereinafter, by way of example only, with reference to the accompanying drawings, in which:

FIG. 1 is a flow diagram of a method for modifying behaviour in an individual; and

FIG. 2 is a flow diagram of a method of self-improvement for an individual.

### DETAILED DESCRIPTION

Methods and products are described herein for modifying the behaviour of an individual. Certain embodiments described herein are described with specific reference to modifying negative behaviour, however, it is not intended that the present invention be limited in this manner as the principles of the present invention also have application to modifying or enhancing positive behaviour in individuals.

The present inventor hypothesized that a change in behaviour in a specific individual can be induced by a personal visualization of positive and/or negative consequences of that behaviour in that particular individual. Such visualization, particularly with personal identification and elicitation of a strong emotional response, is significantly more likely to induce a behavioural change in the individual than by watching or hearing about a behaviour and consequence in another unrelated individual. The hypothesis was stimulated by the present inventor's observation that cardiac patients, who previously found it difficult or impossible to give up smoking, can more readily give up smoking after having experienced a heart attack. Empirical evidence suggests that behavioural change is influenced by adrenaline (catecholamine) levels at the time of the learned experience.

A corollary to the foregoing hypothesis is that success in conventional behaviour modification or preventative measures is limited in part due to individuals being largely unable to truly visualize the potential consequences of their actions. For example, smokers are unable to sufficiently identify with an increased risk of heart attack or stroke and alcohol consumers are unable to sufficiently link excessive alcohol consumption and driving accidents. Embodiments of the present invention may advantageously cause an individual to feel that they are participating in a particular scenario. In other words, the individual has a feeling of “this me” or “this could be me”.

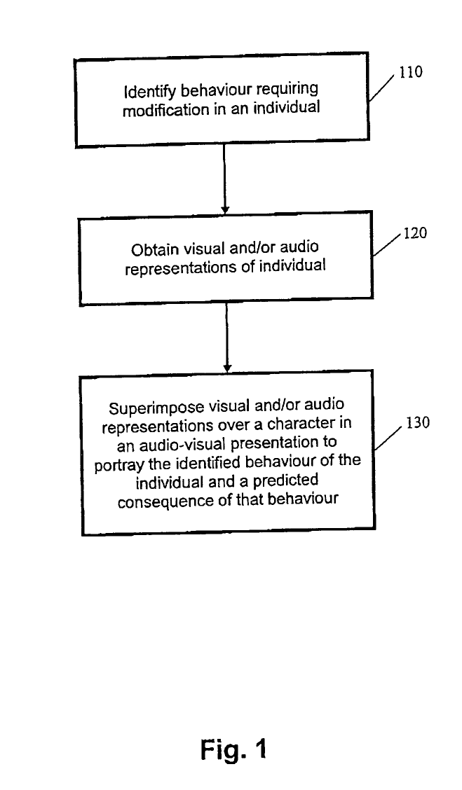

FIG. 1 shows a method for modifying behaviour in an individual. Referring to FIG. 1, a particular behaviour in an individual requiring modification is identified at step 110. Visual and/or audio representations of the individual are obtained, at step 120. The visual and/or audio representations are introduced into an audio-visual presentation to portray the identified behaviour of the individual and a predicted consequence of the behaviour, at step 130. For example, visual representations of the individual may be superimposed over an existing character to effectively portray the individual and recorded or synthesized audio of the individual's voice may be used in soundtrack of the presentation. At step 140, the audio-visual presentation is screened to the individual.

Visual and/or audio representations of one or more other individual/s known to the individual may be obtained and used in the audio-visual presentation. Such other individuals may include, but are not limited to, relatives and friends of the individual whose behaviour it is desired to modify. The audio-visual presentation may be produced using generic characters (e.g., actors) to portray the particular behaviour and associated consequences prior to being personalized.

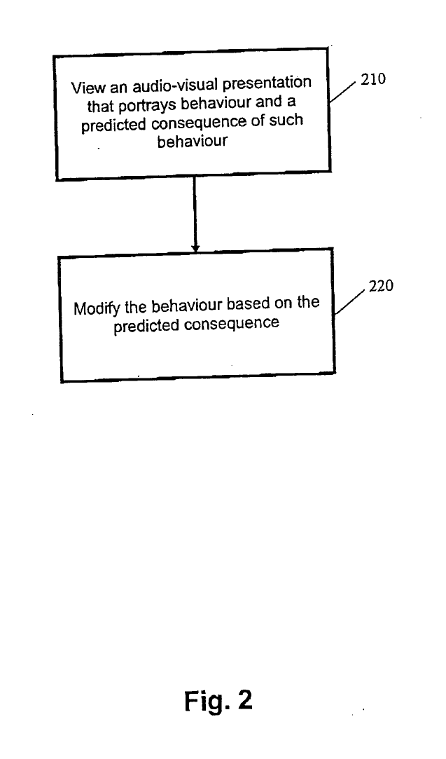

FIG. 2 shows a method of self-improvement for an individual. Referring to FIG. 2, the individual views an audio-visual presentation that portrays behaviour of the individual and a predicted consequence of such behaviour, at step 210. The individual modifies his or her behaviour based on the predicted consequence, at step 220. Motivation for behaviour modification may thus be to avoid negative consequences or to reinforce positive consequences.

The audio-visual presentation may comprise visual and audio representations of the individual. For example, visual representations may be superimposed over a generic character. The audio-visual presentation may further comprise visual and/or audio representations of at least one other individual known to the individual. The visual representations may be superimposed over one or more generic character/s in the audio-visual presentation. Such other individuals may include, but are not limited to, relatives and friends of the individual.

### SCENARIO EXAMPLE

The scenario described hereinafter comprises a number of scenes, which are representative of an example of content of an audio-visual presentation in accordance with an embodiment of the present invention. The embodiment relates to smoking in an individual.

### Scene 1

### Ignoring Warning of Smoking

The individual is depicted smoking in the audio-visual presentation. Relatives and friends of the individual are shown imploring the individual to stop smoking because of their fear that the individual will have a heart attack or develop lung cancer. The individual tells friends and relatives of his/her intention to stop smoking soon and that they should not be worried.

### Scene 2

### Having a Heart Attack while Smoking

The individual is shown complaining of pressure in his central chest area and left arm, while smoking. The individual is sweating, short of breath, nauseous and hears his own voice complaining of the pain and reflecting anxiety. Anxious family members are shown crying in fear. Their faces, which were previously superimposed on characters in the audio-visual presentation, are now shown distorted in fear. Jerking of the image simulates stumbling and swaying of the individual. As the chest pressure continues and sweating increases, an ambulance is sent for. The ambulance attendants come into view showing concern and saying “This guy's having a heart attack . . . quick let's get him to the hospital”. Suddenly there is a burst of white light followed by blackness. Voices are heard saying that the individual's heart has stopped. Intermittent pressure is created with more flashes of light and darkness. Finally, someone says “Too late—he's died”. Crying is heard.

### Scene 3

### At the Funeral

A funeral scene is displayed with attendees dressed in black and crying as the coffin is lowered into the ground. Someone says—“Joe was a fool—if he hadn't continued smoking cigarettes, he'd be alive now”.

### Scene 4

### Some Months after the Death

Family members and friends are shown sitting in a room saying how their lives have been devastated by the loss of the individual. Three different generations including older people and the individual's spouse and young children are shown, all expressing their loss and how needless it was—their lives are ruined by this death and they are left to mourn and try to rebuild their lives. Children without a parent and a parent without a spouse. The images represent personal scenes for the individual, having been superimposed onto generic characters in the presentation. Similarly, voices in the presentation represent the voices of the individual and relatives and/or friends of the individual.

### Scene 5

### Subsequent Hardship

The individual's spouse (e.g., wife) is shown speaking to a doctor, depressed and saying that she can't cope. The doctor replies that cigarettes do terrible things to one's body such as increasing the chances of a clot blocking an artery, of having a stroke and of developing lung cancer. The doctor continues that the individual could have stopped smoking but chose not to.

The audio-visual presentation may comprise specific personal information relating to the individual and relatives and/or friends of the individual to enrich personal attributes and make the presentation more real. Further, the visual and audio representations may be processed (e.g., distorted) to convey intense sorrow and grief of relatives and friends. The individual's experience may also be enhanced by presenting the audio-visual presentation in a highly emotive manner. In effect, the individual would see himself/herself as truly participating in a “this is me” sense rather than in a “this could be me” sense. Such an experience is significantly more realistic than, say, a television image of a car crash of a drink-driving victim, in which people can rationalize that the probability of that happening to them is sufficiently remote.

The visual and audio representations may comprise digital pictures or videos and audio recordings, respectively. The audio-visual presentation may comprise, but is not limited to, a recorded video such as a digital or analog video track, a digital video clip (e.g., MPEG) or a Microsoft PowerPoint Presentation. Either or both of the visual and audio representations and the audio-visual presentation may be distributed and/or transferred by means of a physical carrier (e.g., a VHS or Beta video, a DVD and a CD) or via the Internet. Superimposition of the visual and audio representations may be performed using commercially available software tools for performing digital editing.

In one particular embodiment, the commercially-available software program Macromedia Flash MX 2004 was used to personalize a video sequence of an actor (e.g., a generic individual) created using a digital video camera. Digital images (e.g, frontal, profile, different expressions) of a particular individual and their family and friends were obtained using a standard digital camera. The digital images were imported into the Macromedia Flash MX 2004 program and superimposed over the generic actors in the original video sequence, which was then edited using flash techniques such as animation, pan, scan and zoom. The resulting audio-visual presentation proved motivating to the particular individual for self-improvement through modified behaviour.

Applications of the methods and products described herein include, but are not limited to:
Reinforcement to stop or ameliorate negative behaviour such as alcohol intoxication, alcoholism, drug abuse, road rage, anger, child abuse, spouse abuse and bullying;
Reinforcement to encourage positive behaviour such as exercise and diet control leading to weight loss and good body image, anger management and practice of a technique such as a golf swing leading to an improved performance;
Genetic counseling to enable individuals to more realistically understand and appreciate consequences of their genetic makeup or disposition; and
Entertainment wherein the individual is the star of a movie.

Similar personalized audio-visual presentations may be used to modify behaviour in multiple individuals requiring modification of the same or a similar type of behaviour.

Further embodiments of the present invention provide an additional degree of realism by way of physical stimuli applied to the individual. The audio-visual presentation may be screened to the individual in an environment of cigarette smoke. In certain embodiments, the individual wears a suit containing pressure transducers that provide pressure to the region of the heart at an appropriate time during the audio-visual presentation (i.e., during and/or just prior to onset of a heart attack). In certain embodiments, water or water vapour is produced and applied to the individual to simulate perspiration.

The foregoing description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter. Where specific features, elements and steps referred to herein have known equivalents in the art to which the invention relates, such known equivalents are deemed to be incorporated herein as if individually set forth. Features, elements and steps referred to in respect of particular embodiments may optionally form part of any of the other embodiments, unless specified to the contrary.

The term “comprising”, as used herein, is intended to have an open-ended, non-exclusive meaning. For example, the term is intended to mean: “including principally, but not necessarily solely” and not to mean “consisting essentially of” or “consisting only of”. Variations of the term “comprising”, such as “comprise”, “comprises” and “is comprised of”, have corresponding meanings.

I claim:

1. A method for modifying behaviour in an individual, said method comprising the steps of:
identifying behaviour in an individual to be modified;
obtaining visual representations of said individual;
superimposing said visual representations over a character in an audio-visual presentation to portray said identified behaviour of said individual and a predicted consequence of said behaviour; and
screening said audio-visual presentation to said individual.

2. The method of claim 1, comprising the further steps of:
obtaining visual representations of at least one other individual known to said individual; and
superimposing said visual representations over at least one character in said audio-visual presentation

3. The method of claim 2, wherein said at least one other individual comprises at least one individual selected from the group of individuals consisting of:
relatives of said individual; and
friends of said individual.

4. The method of claim 3, wherein said identified behaviour comprises a negative behaviour selected from the group of negative behaviours consisting of:
smoking, alcoholism, drug abuse, road rage, anger, an eating disorder; bullying, child abuse and spouse abuse.

5. The method of claim 3, wherein said identified behaviour comprises a positive behaviour selected from the group of positive behaviours consisting of:
avoiding driving after drinking alcohol, sensible eating habits, anger management and regular exercise.

6. The method of claim 1, comprising the further step of generating said audio-visual presentation.

7. A method of self-improvement for an individual, said method comprising the steps of:
viewing an audio-visual presentation that portrays behaviour of said individual and a predicted consequence of said behaviour; and
modifying said behaviour based on said predicted consequence.

8. The method of claim 7, wherein said audio-visual presentation comprises visual representations of said individual superimposed over a character in said audio-visual presentation.

9. The method of claim 8, wherein said audio-visual presentation further comprises visual representations of at least one other individual known to said individual, said visual representations superimposed over at least one character in said audio-visual presentation.

10. The method of claim 9, wherein said at least one other individual comprises at least one individual selected from the group of individuals consisting of:
relatives of said individual; and
friends of said individual.

11. The method of claim 10, wherein said identified behaviour comprises a negative behaviour selected from the group of negative behaviours consisting of:
smoking, alcoholism, drug abuse, road rage, anger, an eating disorder; bullying, child abuse and spouse abuse.

12. The method of claim 10, wherein said identified behaviour comprises a positive behaviour selected from the group of positive behaviours consisting of:
avoiding driving after drinking alcohol, anger management, sensible eating habits and regular exercise.

13. A personalized audio-visual presentation for modifying behaviour in an individual, said audio-visual presentation comprising a recording of a character exhibiting said behaviour and a predicted consequence of said behaviour, wherein visual representations of said individual are superimposed over said character in said audio-visual presentation.

14. The personalized audio-visual presentation of claim 13, further comprising a recording of at least one other individual known to said individual, wherein visual representations of said at least one other individual are superimposed over at least one other character in said audio-visual presentation.

15. The personalized audio-visual presentation of claim 14, wherein said at least one other individual comprises at least one individual selected from the group of individuals consisting of:
relatives of said individual; and
friends of said individual.

16. The personalized audio-visual presentation of claim 12, wherein said identified behaviour comprises a negative behaviour selected from the group of negative behaviours consisting of:
smoking, alcoholism, drug abuse, road rage, anger, an eating disorder; bullying, child abuse and spouse abuse.

17. The personalized audio-visual presentation of claim 12, wherein said identified behaviour comprises a positive behaviour selected from the group of positive behaviours consisting of:
avoiding driving after drinking alcohol, anger management, sensible eating habits and regular exercise.

18. The method of claim 1, wherein said visual representations comprise video recordings.

19. The method of claim 7, wherein said visual representations comprise video recordings.

20. The personalized audio-visual presentation of claim 13, wherein said visual representations comprise video recordings.

21. The method of claim 1, comprising the further step of applying a physical stimulus to said individual.

22. The method of claim 1, comprising the further steps of:
obtaining audio representations of said individual; and
adding said audio representations to a soundtrack of said audio-visual presentation.

23. The method of claim 7, comprising the further steps of:
obtaining audio representations of said individual; and
adding said audio representations to a soundtrack of said audio-visual presentation.

24. The personalized audio-visual presentation of claim 13, wherein audio representations of said individual form part of a soundtrack of said audio-visual presentation.
